(19) United States
(12) Patent Application Publication
(10) Pub. No.: US 2004/0247246 A1
(43) Pub. Date: Dec. 9, 2004

(54) Optical power equalizer in a passive optical network

(76) Inventors: Jeong-Seok Lee, Anyang-shi (KR); Joong-Hee Lee, Songnam-shi (KR); Seong-Taek Hwang, Pyongtaek-shi (KR)

Correspondence Address: CHA & REITER, LLC, 210 ROUTE 4 EAST STE 103, PARAMUS, NJ, 07652, US

(21) Appl. No.: 10/692,348

(22) Filed: Oct. 23, 2003

(30) Foreign Application Priority Data
Jun. 9, 2003 (KR) 2003-36806

(51) Int. Cl. G02B 6/26

(52) U.S. Cl. 385/48; 385/27

(57) ABSTRACT

An optical power equalization method and an optical power equalizer for optical signals traveling upstream in a passive optical network are disclosed. The equalizer includes a wavelength coupler, an optical splitter, an optical detector, an active gain control circuit, a delay element, and an optical amplifier. The wavelength coupler separates an upstream optical signal from a single optical fiber. The optical splitter transfers a part of the optical signal to the optical detector. The optical detector converts the optical signal from the coupler into an electrical signal having an amplitude proportional to the optical signal's intensity. The control circuit controls a driving current to be provided to the amplifier, according to the electrical signal's amplitude. The delay element delays the optical signal by a time required for the optical detector and the control circuit to perform their operation. The amplifier amplifies the optical signal with a gain according to the driving current from the control circuit.

### CLAIM OF PRIORITY

This application claims priority to an application entitled “OPTICAL POWER EQUALIZER IN PASSIVE OPTICAL NETWORK,” filed in the Korean Intellectual Property Office on Jun. 9, 2003 and assigned Serial No. 2003-36806, the contents of which are hereby incorporated by reference.

### BACKGROUND OF THE INVENTION

1. Field of the Invention

The present invention relates to an optical power equalizer in a passive optical network.

2. Description of the Related Art

A rapid increase in the demand for broadband multimedia (e.g., transmitted over the Internet or other networks) has brought about a need for an optical network with optical lines (i.e., FTTH: Fiber To The Home) extending into various building and residences. To meet this need, a PON (Passive Optical Network) has been proposed. The PON has a point-to-multipoint structure in which a number of ONUs (Optical Network Units) share an OLT (Optical Line Termination) through a single optical fiber. The PON is classified into an ATM PON (hereinafter referred to as an “APON”) and an Ethernet PON (hereinafter referred to as an “EPON”) according to the transmission schemes employed for information exchange with subscribers.

FIG. 1 shows the configuration of a PON that includes an OLT 50 in a central office, a passive optical splitter 40, and a plurality of ONUs 10, 20 and 30 respectively corresponding to various subscribers.

For communication from the single OLT 50, as shown in FIG. 1, to one or more of the ONUs 10, 20 and 30, data is simultaneously transmitted downstream (i.e., from the OLT to the ONUs). For data transmission from one or more of the ONUs 10, 20 and 30 to the single OLT 50, a TDMA (Time Division Multiple Access) scheme is employed. This is done to avoid collision between signals transmitted from the ONUs 10, 20 and 30. Because the ONUs 10, 20 and 30 have different operating conditions and different distances from the single OLT 50, optical signals uploaded from the ONUs 10, 20 and 30 have different optical powers from the point of view of a receiver (i.e., the OLT 50).

Although downstream signals from the OLT 50 to the ONUs 10, 20 and 30 have different power intensities when they reach the ONUs 10, 20 and 30 respectively corresponding to subscribers, there is no problem in processing them in such a PON system because an optical receiver in each of the ONUs 10, 20 and 30 processes signals having a single power. However, it is very difficult for an optical receiver of the OLT 50 to process upstream signals 12, 22 and 32 transmitted from the ONUs 10, 20 and 30 to the OLT 50, when the signals 12, 22 and 32 incoming from the ONUs 10, 20 and 30 have different intensities.

In order to overcome such a problem, the OLT 50 requires a burst-mode optical receiver capable of processing signals having various optical powers.

By removing a DC block capacitor used in an AC coupling mode of a general receiver, the burst-mode optical receiver prevents burst data loss caused by the capacitor's charging/discharging times. It also extracts a detection threshold as a reference signal for data detection for each received burst packet. In addition, the burst-mode optical receiver recovers the data by amplifying it symmetrically with respect to the extracted detection threshold.

FIG. 2 is a block diagram showing an example of a conventional burst-mode optical receiver that includes an optical detector 60, a pre-amplifier 72, an automatic threshold controller (hereinafter referred to as an “ATC”) 74, and a limiting amplifier 76.

The optical detector 60 converts a received optical signal into a current signal. The pre-amplifier 72, composed of a transimpedance amplifier (TIA), converts the current signal detected in the optical detector 60 into a voltage signal. After being amplified in the pre-amplifier 72, the received signal is input to the ATC 74 and the limiting amplifier 76. The ATC 74 extracts a detection threshold of a packet received from the pre-amplifier 72. The detection threshold is changed automatically through the ATC 74 according to the size of the packet. The limiting amplifier 76 recovers signals of different amplitudes from the pre-amplifier 72 into signals of a uniform amplitude according to their detection threshold input from the ATC 74.

However, the burst-mode optical receiver may cause performance degradation in the transmission system when there is high data congestion due to limitations on the time assignment. In particular, after converting a burst optical signal into an electrical signal, the burst-mode optical receiver extracts its detection threshold, and recovers it to a signal of a uniform amplitude according to the detection threshold. Thus, it is impossible to recover burst optical signals from the ONUs if they are input without some time intervals for detecting their detection thresholds.

In addition, the burst-mode optical receiver is an obstacle to grouping subscribers or increasing the transmission speed because high optical loss occurs in elements used in the transmission system.

Accordingly there is a need in the art for improved optical networks.

### SUMMARY OF THE INVENTION

One object of the present invention is to solve the shortcoming noted above.

One embodiment of the present invention is directed to an optical power equalizer wherein a very short switching time (ns) characteristic of a semiconductor optical amplifier is utilized so that a driving current for the amplifier is controlled to change its gain, with respect to different input intensities of signals incoming from optical subscribers, for a short time of nanoseconds, so as to always keep the optical intensities of the signals incoming from a number of the ONUs uniform.

Another embodiment of the present invention is directed to an optical power equalizer for optical signals traveling upstream in a passive optical network. The equalizer includes a wavelength coupler for separating an optical signal traveling upstream from a single optical fiber, and an optical splitter for allowing a part of the upstream optical signal to be transferred to an optical detector for detecting its optical output in order to obtain the upstream optical signal's intensity. The optical detector converts the optical signal output from the wavelength coupler into an electrical signal having a signal amplitude proportional to the optical signal's intensity and outputs the converted electrical signal. The equalizer also includes an active gain control circuit for controlling a driving current to be provided to an optical amplifier, according to the electrical signal's amplitude, a delay element for delaying the optical signal by a time required for the optical detector and the active gain control circuit to perform their operation. The optical amplifier amplifies the optical signal with an amplification gain according to the driving current from the active gain control circuit.

One aspect of an optical power equalizer according to various embodiments of the present invention is that it can be used very effectively in a time-demuxing transmission, and it can also simultaneously perform an amplification function, thereby compensating various optical losses occurring during transmission.

### BRIEF DESCRIPTION OF THE DRAWINGS

The above and other objects, features and other advantages of the present invention will be more clearly understood from the following detailed description taken in conjunction with the accompanying drawings, in which:

FIG. 1 shows the configuration of a PON (Passive Optical Network);

FIG. 2 shows a block diagram of a conventional burst-mode optical receiver;

FIG. 3 shows a PON (Passive Optical Network) employing an optical power equalizer according to aspects of the present invention;

FIG. 4 shows the configuration of an optical power equalizer according to aspects of the present invention;

FIG. 5 is a graph showing the relationship between a driving current from an active gain control circuit and an optical amplifier's gain; and

FIGS. 6 and 7 illustrate the switching time of an optical amplifier in accordance with aspects of the present invention.

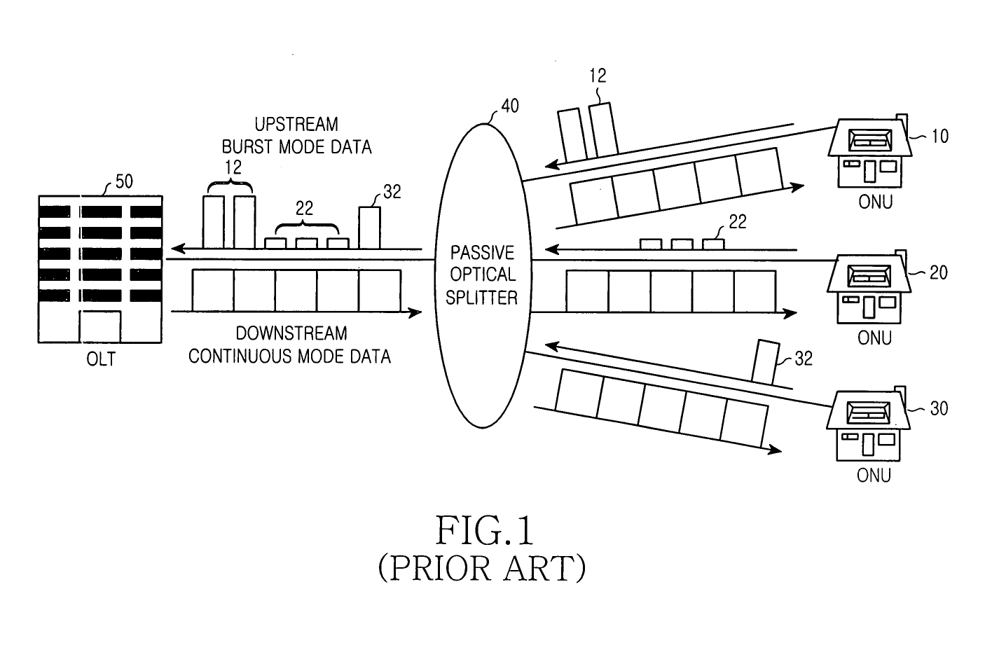

### DETAILED DESCRIPTION OF THE PREFERRED EMBODIMENTS

Now, preferred embodiments of the present invention will be described in detail with reference to the annexed drawings. For the purposes of clarity and simplicity, a detailed description of known functions and configurations incorporated herein will be omitted when it may obscure the subject matter of the present invention.

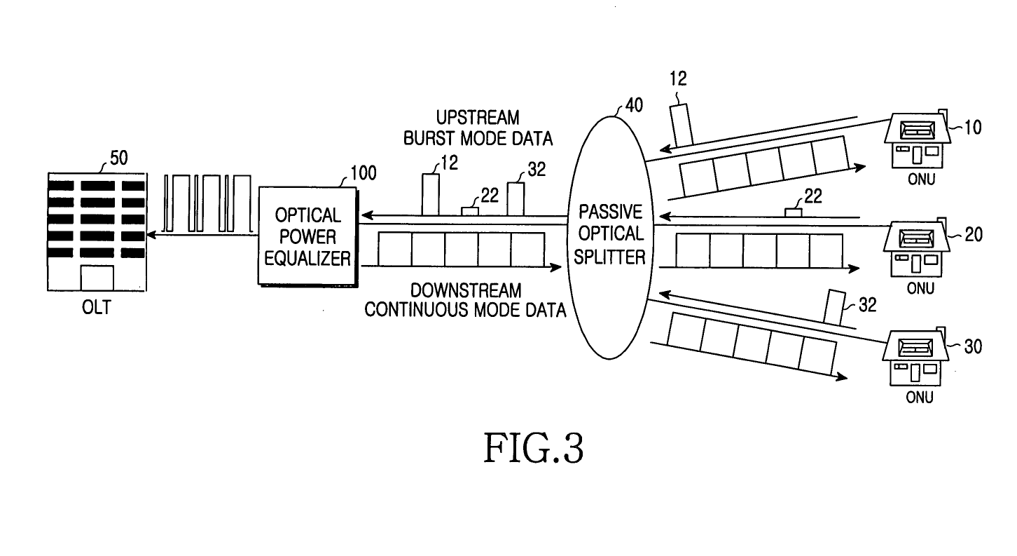

FIG. 3 shows a PON (Passive Optical Network) employing an optical power equalizer 100 according to aspects of the present invention.

As shown in FIG. 3, the PON includes an OLT (Optical Line Termination) 50, a passive optical splitter 40, and a plurality of ONUs 10, 20 and 30 corresponding to subscribers. The PON further includes an optical power equalizer 100 according to aspects of the present invention. The optical power equalizer 100 receives optical signals transmitted from one or more of the ONUs 10, 20 and 30 to the OLT 50. to the optical power equalizer 100 allow the received optical signals (by the OLT 50) to have a uniform optical power. Upstream optical signals, respectively, incoming from the ONUs 10, 20 and 30 of the subscribers through different optical paths have different powers because the ONUs 10, 20 and 30 have different distances from the OLT 50. The optical power equalizer 100 amplifies the optical signals having different optical intensities with different gains according to their intensity, so as to allow them to have a uniform optical power.

In order to overcome the problems associated with upstream optical signals incoming from subscribers to a base station having different intensities because the subscribers have different conditions and different distances from the PON, in the prior art, a burst-mode optical receiver is adopted to detect different signal intensities respectively corresponding to subscribers after converting the optical signals into electrical signals. The signals must pass by an ATC (Automatic Threshold Controller) and a limiting amplifier in order to output signals having a uniform power. However, in accordance with aspects of the present invention, an optical amplifier amplifies the optical signals with its gain controlled in proportion to their signal intensity.

Because of amplifying the optical signals themselves to obtain a uniform optical power, there is no need, as in the prior art, to employ a complicated burst-mode optical receiver circuit in order to output electrical signals of a uniform intensity corresponding to the converted electrical signals.

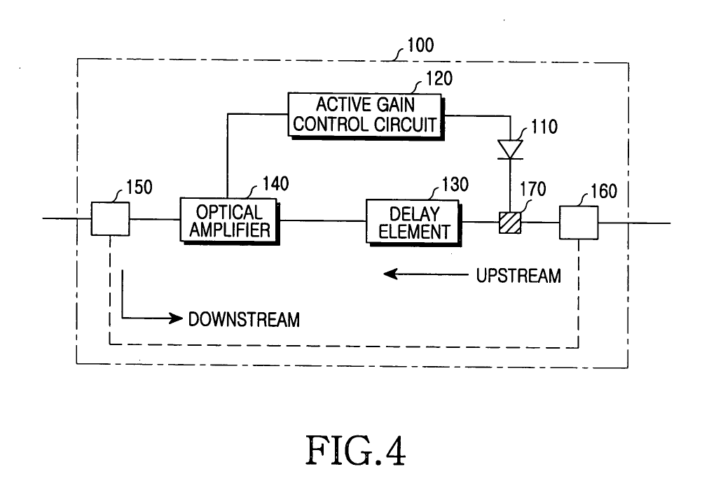

FIG. 4 shows the configuration of an optical power equalizer according to an embodiment of the present invention. The optical power equalizer 100 includes a wavelength coupler 160, an optical splitter 170, an optical detector 110, and an active gain control circuit 120. The wavelength coupler 160 separates an optical signal traveling upstream from a single optical fiber. The optical splitter 170 transfers a part of the upstream signal to the optical detector 110. The optical detector 110 receives the optical signal from the wavelength coupler 160, and converts it into an electrical signal having an amplitude corresponding to the optical signal's intensity. The active gain control circuit 120 controls a driving current to be provided to an optical amplifier 140, according to the amplitude of the electrical signal from the optical detector 110.

In addition, a delay element 130 is disposed between the optical amplifier 140 and the optical splitter 170. This allows the time for the optical signal to reach the optical amplifier 140 to be delayed by the time during which the optical detector 110 detects the optical signal and the active gain control circuit 120 controls the gain of a current to be provided to the optical amplifier 140 in proportion to the intensity of the detected signal. In this regard, the optical power equalizer 100 delays the time, during which an optical signal is input to the optical amplifier 140 and the optical amplifier is driven, by the time required for the optical detector 110 and the active gain control circuit 120 to perform their operation for the optical signal, through the delay element 130 such as, for example, a fiber loop, so that the time at which the optical amplifier 140 performs amplification by its current driving coincides with the time at which the optical signal passes by the amplifier 140.

The optical power equalizer 100 also includes the wavelength coupler 160 for separating upstream and downstream signals, transmitted and received through a single optical fiber, from each other. The equalizer 100 further includes the optical splitter 170 for transferring a part of the upstream signal to the optical detector 110, and a wavelength coupler 150 for combining the optically-amplified upstream optical signal with the downstream optical signal.

The operation of the optical power equalizer 100 will be described as follows. In the PON, optical signals of different amplitudes are transmitted from one or more ONUs to a single OLT, as described above. The optical signals transmitted toward the OLT are input to the optical power equalizer 100 so as to have a uniform level of optical intensity.

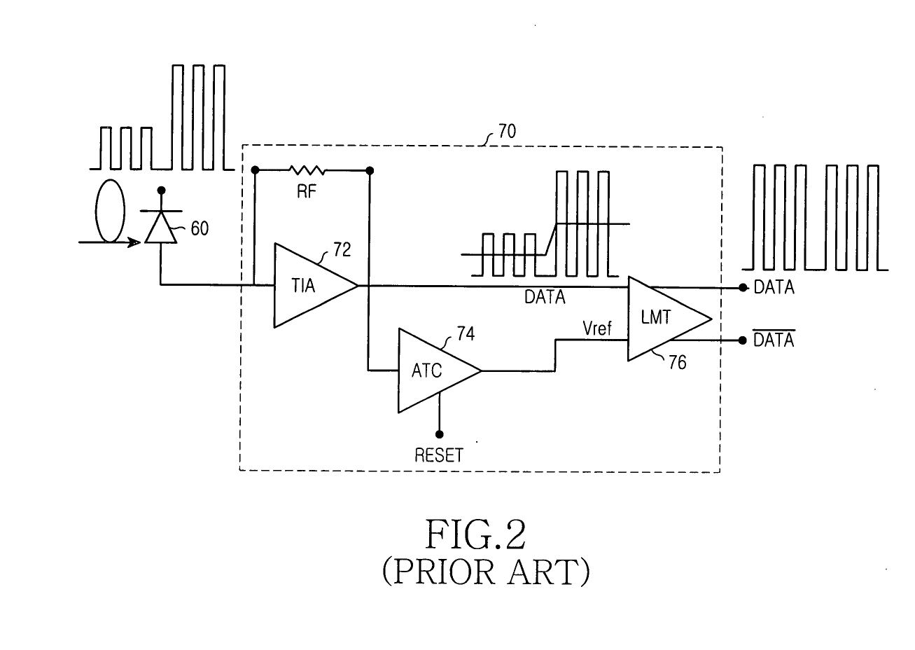

The traveling path of optical signals input to the optical power equalizer 100 is described as follows. A downstream signal input to the wavelength coupler 150 travels along a path denoted by a dotted line in FIG. 4, and, after being combined through another wavelength coupler 160, it is transferred to the ONUs along the path of the single optical fiber. On the other hand, an upstream signal input to the wavelength coupler 160 travels along a path denoted by a solid line in FIG. 4. A part of the optical signal outputted from the wavelength coupler 1 60 is transferred to the optical detector 110 through the optical splitter 170. Its remaining part passes by the delay element 130, and is transferred to the OLT's optical detector 60 shown in FIG. 2 through the wavelength coupler 150, after obtaining a desired gain through the optical amplifier 140.

When a part of the upstream optical signal is input to the optical detector 110 through the optical splitter 170, the optical detector 110 converts the input optical signal into an electrical signal, and outputs it to the active gain control circuit 120. The electrical signal output from the detector 110 has a signal amplitude proportional to the intensity of the optical signal. Upon receipt of the electrical signal from the optical detector 110, the active gain control circuit 120 provides the optical amplifier 140 with a driving current having an amplitude in accordance with the electrical signal's amplitude. In particular, the active gain control circuit 120 outputs a driving current having an amplitude inversely proportional to the intensity of the optical signal from the optical detector 110. Accordingly, an optical signal having a low optical power is amplified with a high amplification gain, whereas an optical signal having a high optical power is amplified with a low amplification gain. Thus, if the signal from the optical detector 110 has a high amplitude, the active gain control circuit 120 outputs a low driving current to the optical amplifier 140, so as to amplify the optical signal with a low amplification gain. Similarly, if the signal from the optical detector 110 has a low amplitude, the active gain control circuit 120 outputs a high driving current to the optical amplifier 140, so as to amplify the optical signal with a high amplification gain. In this regard, the active gain control circuit 120 outputs a driving current having an amplitude inversely proportional to the intensity of the optical signal from the optical detector 110.

The optical amplifier 140 receives the driving current from the active gain control circuit 120 to amplify the input upstream optical signal. When receiving a driving current having a high amplitude, the optical amplifier 140 amplifies the input optical signal with a high gain, whereas when receiving a driving current having a low amplitude, the amplifier 140 amplifies it with a low gain.

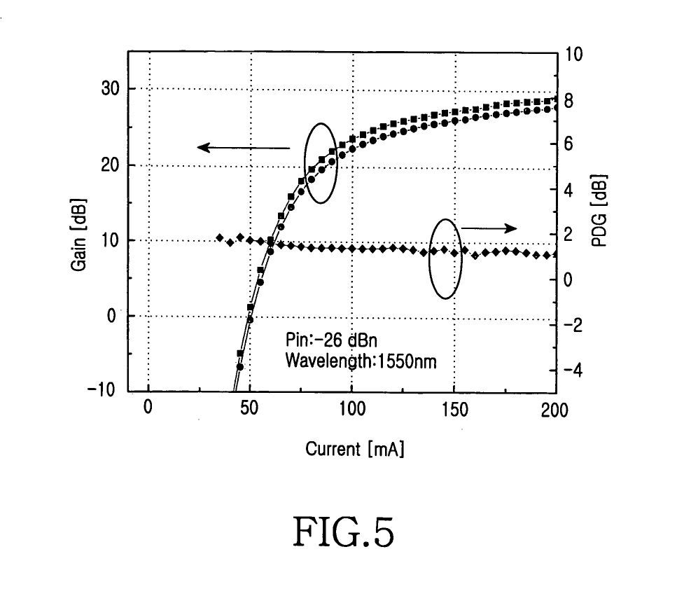

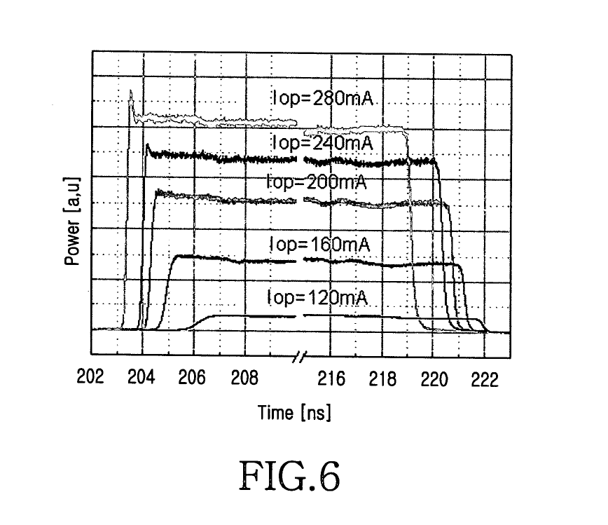

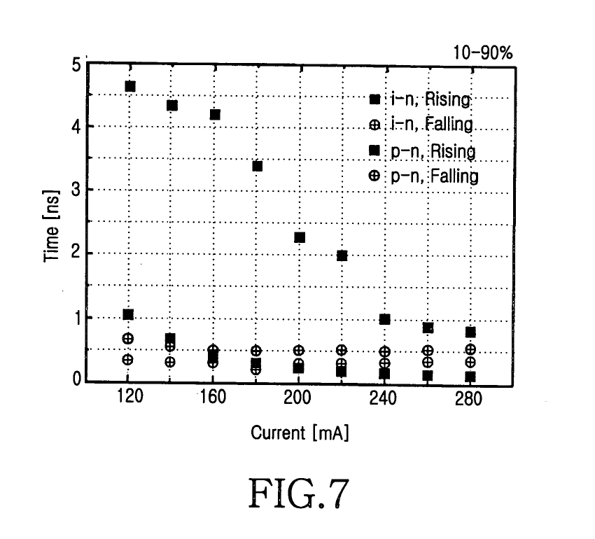

FIG. 5 is a graph showing the relationship between a driving current from the active gain control circuit 120 and the optical amplifier's 140 gain. In this graph, the horizontal axis represents the driving current provided from the active gain control circuit 120 to the optical amplifier 140, and the vertical axis represents the corresponding optical-signal amplification gain of the optical amplifier 140. The optical amplifier 140 has an optical-signal amplification gain substantially proportional to a driving current input to the amplifier 140. When the input driving current is equal to or more than a predetermined value, the corresponding optical-signal amplification gain remains almost unchanged. In such a manner, the optical amplifier 140 optically amplifies an optical signal output from the delay element 130 with an optical-signal amplification gain according to the driving current. The switching time of the optical amplifier 140 is shown in FIGS. 6 and 7.

FIGS. 6 and 7 illustrate the switching time of the optical amplifier. The optical amplifier 140 has a very short switching time (ns). As described above, a driving current for the optical amplifier 140 is controlled to change its gain, with respect to different input intensities of signals incoming from optical subscribers, for a short time of nanoseconds, so as to always keep the intensities of the optical signals entering the optical detector uniform.

As also described above, the delay element 130, disposed between the optical amplifier 140 and the optical splitter 170, delays an upstream optical signal, output from the wavelength coupler 160, by the time during which the optical detector 110 detects the intensity of the input optical signal and a driving current for the optical amplifier 140 is adjusted. The delay element 130 may include, for example, a fiber loop. Thereby, the time at which the optical amplifier 140 performs amplification by its current driving coincides with the time at which the optical signal passes by the amplifier 140.

Preferably the optical amplifier 140 is a semiconductor optical amplifier. This because such semiconductor optical amplifiers have a very short switching time (ns), so that a driving current for the amplifier 140 may be controlled to change its gain, with respect to different input intensities of signals incoming from optical subscribers, for a short time of nanoseconds and to keep the optical intensities of the upstream signals uniform.

The optical power equalizer according to embodiments of the present invention, as described above, is configured to directly make optical signals of different intensities have a uniform level of optical power. This allows the electronic circuits used in the transmission system to be simplified without sacrifice of the sensitivity of an optical receiver through the amplification function and thereby achieving high bit-rate data transmission. In addition, the gap time between burst signals is minimized to enlarge the transmission capacity because the optical amplifier of the optical power equalizer has a high switching speed. Further, embodiments of the present invention are advantageous over conventional methods employing conventional electric elements in terms of grouping subscribers because the loss difference due to variations in the distance between the optical subscribers (ONUs) and the passive optical coupler can be compensated by the amplifier's gain.

Furthermore, the optical power equalizer according aspects of the present invention has an advantage in that it can be used very effectively in a time-demuxing transmission, and it can also compensate various optical losses occurring during transmission by simultaneously performing the amplification function. These features reduce the overall cost of the PON

Although the preferred embodiment of the present invention has been disclosed for illustrative purposes, those skilled in the art will appreciate that various modifications, additions and substitutions are possible, without departing from the scope and spirit of the invention as disclosed in the accompanying claims.

What is claimed is:

1. An optical power equalizer, comprising:
a wavelength coupler for separating an optical signal traveling upstream from a single optical fiber;
an optical splitter for allowing a part of the upstream optical signal to be transferred to an optical detector for detecting the upstream optical signal's intensity, the optical detector outputting an electrical signal having a signal amplitude proportional to the upstream optical signal's intensity;
an active gain control circuit for controlling a driving current to be provided to an optical amplifier, according to the electrical signal; and
a delay element for delaying the upstream optical signal by a time required for the optical detector and the active gain control circuit to perform their operation,
wherein the optical amplifier amplifies the upstream optical signal with an amplification gain according to the driving current from the active gain control circuit.

2. The optical power equalizer as set forth in claim 1, wherein the delay element includes a fiber loop.

3. The optical power equalizer as set forth in claim 1, wherein the optical amplifier is a semiconductor optical amplifier.

4. The optical power equalizer as set forth in claim 3, wherein the semiconductor optical amplifier has a switching time having an order of magnitude of nanoseconds.

5. The optical power equalizer as set forth in claim 1, wherein the active gain control circuit outputs a driving current having an amplitude inversely proportional to the intensity of the upstream optical signal.

6. A method for optical power equalization for optical signals traveling upstream in a passive optical network, the method comprising the step of:
separating an optical signal traveling upstream from a single optical fiber;
detecting the upstream optical signal's intensity;
providing an indication of the upstream optical signal's intensity;
delaying the upstream optical signal, and
amplifying the upstream optical signal in accordance with the indication to keep the optical intensities of upstream signals incoming from a plurality of Optical Network Units uniform.

7. The method as set forth in claim 6, wherein said delaying step delays the upstream optical signal a time having an order of magnitude of nanoseconds.
